(19) United States
(12) Patent Application Publication
(10) Pub. No.: US 2022/0089360 A1
(43) Pub. Date: Mar. 24, 2022

(54) WASTE REDUCING CONTAINER

(71) Applicant: John J. Sweeney, Downers Grove, IL (US)

(72) Inventor: John J. Sweeney, Downers Grove, IL (US)

(21) Appl. No.: 17/479,105

(22) Filed: Sep. 20, 2021

Related U.S. Application Data
(60) Provisional application No. 63/080,732, filed on Sep. 20, 2020.

(51) Int. Cl. B65D 88/52; B65D 77/06; B65D 43/16; B65D 90/00; B65D 90/58

(52) U.S. Cl. CPC B65D 88/524; B65D 77/06; B65D 90/587; B65D 90/0086; B65D 43/166

(57) ABSTRACT

A container employs a reusable frame that folds into a compact profile that can be stacked for efficient handling between uses, thus greatly reducing waste that would otherwise end up in landfills. The container has external dimensions emulating those of existing single-use containers, including those designed to accommodate pliable plastic pouch liners for transport and dispensing of material. The container includes a front side having a 17.5 radius cutout to accept a 35 mm fitment of a standard pliable plastic pouch liner, and includes a sliding door which captures and holds the liner fast in place. The container includes a top side having a hinged, latching door with one or more hinges to allow insertion and removal of a pliable plastic pouch. A latching, sliding door allowing access to a dispensing nipple of a contained pliable plastic pouch when inserted into the container.

### RELATED APPLICATIONS

This application claims priority to U.S. Provisional Patent Application No. 63/080,832 filed on Sep. 21, 2020 by the same inventor and entitled “Waste Reducing Container.”

### BACKGROUND

The present invention relates generally to reusable containers for materials, and more particularly to a reusable container for certain materials, such as soft solids, liquids, and gases, including but not limited to, beverages and beverage ingredients, such as syrup and water, oil and other fluids, gases, powders, etc.

The prior standard for packaging and delivery of many fluids has been a rigid cardboard box enclosing a pliable plastic pouch or bladder containing the fluid. After it is emptied, the full box and pouch are typically disposed of as a unit in the full original size. Because of the mixing of materials (cardboard box and plastic pouch), these prior containers are not recyclable, so the prior containers must be sent to landfills.

The present invention is therefore directed to the problem of developing a reusable shipping container for materials, including, but not limited to soft solids, liquids, and gases, including but not limited to, beverages and beverage ingredients, such as syrup and water, oil and other fluids, gases, powders, etc., wherein said container can be recycled after its lifetime of use.

### SUMMARY OF THE INVENTION

The present invention solves these and other problems by providing a container with a reusable frame that folds into a compact profile that can be stacked for efficient handling between uses, thus greatly reducing waste that would otherwise end up in landfills.

In view of the foregoing disadvantages inherent in the known types of containers now present in the prior art, the present invention provides a new container construction wherein the same can be utilized for enabling reuse of most of the mass of the container, eliminating the wasteful requirement of sending all of that material to landfills.

The general purpose of the present invention, which will be described subsequently in greater detail, is to provide a new container that has the advantages of the container mentioned heretofore and many novel features that result in a new container which are not anticipated, rendered obvious, suggested, or even implied by any of the prior art containers, either alone or in any combination thereof.

To attain this, the present invention generally comprises a durable plastic frame that protects its contents in transit and use, then can be easily folded or collapsed and stacked for efficient and convenient storage and shipment for reuse.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a container that will overcome the shortcomings of the prior art devices.

A second object is to provide a container for eliminating the requirement of sending all of the material of the container to landfills after use.

Another object is to provide a container that can be collapsed or folded easily, after the contents have been exhausted, into a much smaller profile which can be stacked and stored for return and reuse.

An additional object is to provide a container that is an improvement upon conventional containers.

A further object is to provide a container that is structurally sturdier than the cardboard construction of the prior art.

An additional object is to provide container that is much less susceptible to absorbing fluids than the prior art, and easily cleaned for reuse.

Another object is that most or all of the materials can be recycled materials, and can be recycled again at eventual the end of life of the container.

According to one aspect of the present invention, an apparatus for holding a material includes a container with six sides. The container creates a reusable frame that folds into a compact profile that can be stacked for efficient handling between uses. The container may have external dimensions emulating those of existing single-use containers, including those designed to accommodate pliable plastic pouch liners for transport and dispensing of material. The container may include a front side having a 17.5 mm radius cutout to accept a 35 mm fitment of a standard pliable plastic pouch liner. The container may include a sliding door which captures and holds the liner fast in place. The container may include a top side having a hinged, latching door with one or more hinges to allow insertion and removal of a pliable plastic pouch. The hinges may be made of stainless-steel material and may be easily replaceable. The front side may incorporate a latching, sliding door allowing access to a dispensing nipple of a contained pliable plastic pouch when inserted into the container. The front side may incorporate a cutout of dimension designed to accommodate a dispensing nipple of a contained pliable plastic pouch when inserted into the container. The container may have multiple sides that are hinged to allow the sides to fold inward to collapse the container into a compact profile for storage and transportation. The apparatus may include a folded configuration, in which configuration said container can be stacked for storage and transportation along with a plurality of other similar containers. The container may be used multiple times. The container may be made of recycled plastic, recyclable plastic, metal, wood, pressed fiber, ceramic material, woven mesh or fabric, a pliable film sheet or the like, or various combinations of these materials.

According to another aspect of the present invention, a shipping container for transporting liquids or gases includes a foldable frame having hinged sides. The hinged sides are hinged to allow them to fold inward to collapse the frame into a compact profile for storage and transportation. A plastic pouch for holding a liquid or gas is insertable into the frame when unfolded. The pouch includes a predetermined fitment and a dispensing nipple. The foldable frame includes a front side with a predetermined radius cutout to accept the predetermined fitment of the plastic pouch. The front side includes a sliding door which captures and holds the pouch fast in place when in a down and locked position. The sliding door also allows access to the dispensing nipple of the pouch when inserted into the frame.

Other objects and advantages of the present invention will become obvious to the reader, and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an elevational view of an Eco-Box in its non-collapsed, filled state with the sliding door in the down position.

FIG. 2 is an elevational view of the container, illustrating the sliding door having been raised vertically to permit access to the dispensing portion of the flexible liquid dispenser container.

FIG. 3 is an elevational view of the container, illustrating the sliding door securely engaging the dispensing portion of the flexible liquid dispenser container.

FIG. 4 is an elevational view of the container, illustrating the top side of the Eco-Box being open and the sliding door being raised for removal of an empty flexible liquid dispenser container.

FIG. 5 is an elevational view of the container, illustrating the empty flexible liquid dispenser container having been removed.

FIG. 6 is an elevational view of the container, illustrating the top side being closed and the front side in the process of collapsing to the top side

FIG. 7 is an elevational view of the container, illustrating the front and rear sides having folded on to the top side, and the left side and right side collapsing towards each other.

FIG. 8 is an elevational view of the container, illustrating the collapsible reusable Eco-Box container in its collapsed state, ready to be transported and refilled with a full flexible liquid dispenser container.

FIG. 9 is an elevation view of an Eco-Box showing the exterior dimensions of Preferred Embodiment and dimensions of the nominal 17.5 mm radius nearly-semicircular cutout designed to accommodate the 35 mm nominal diameter of the fitment at the base of the pliable pouch, which terminates in the dispensing nipple.

FIG. 10 is a close-up photograph of the 35 mm diameter fitment 210 of a standard pliable plastic liner 200 captured between the 17.5 mm radius cutout of the front side 110 and the lowered sliding door 111.

### DETAILED DESCRIPTION

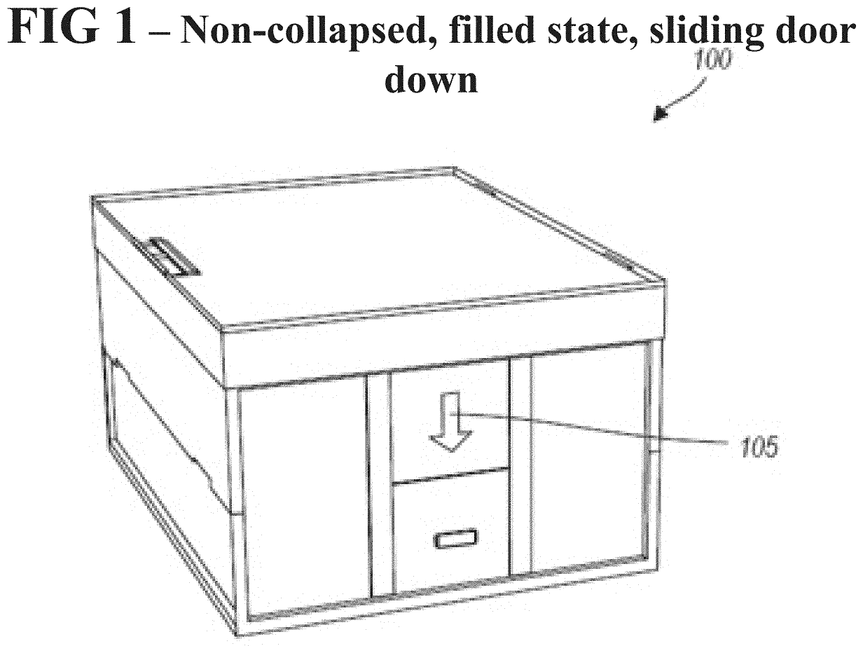

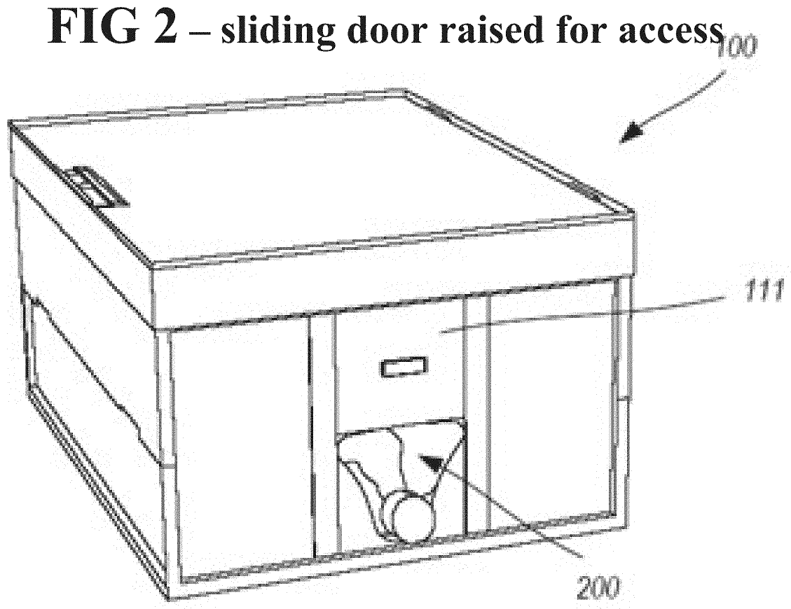

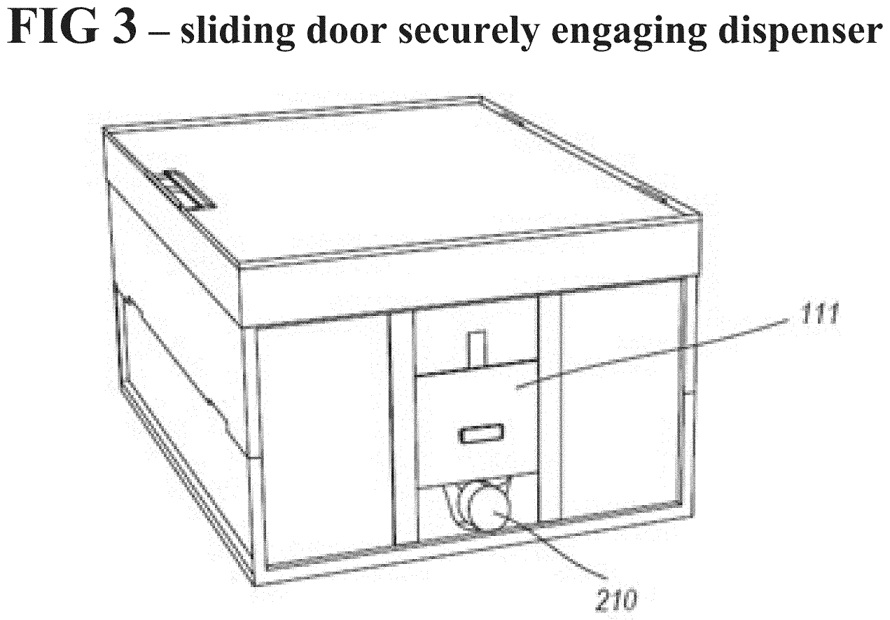

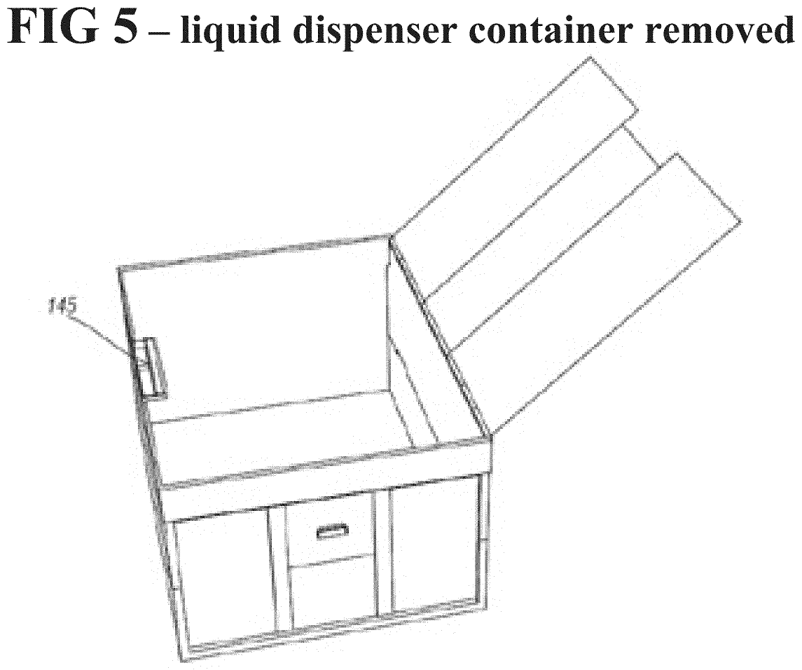

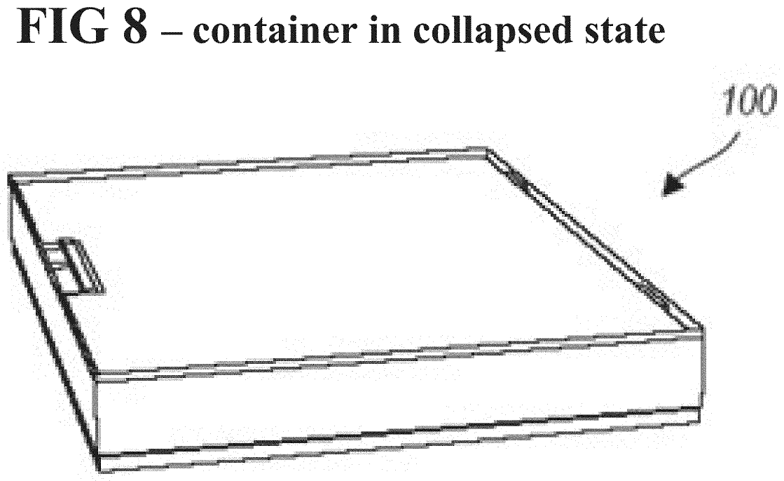

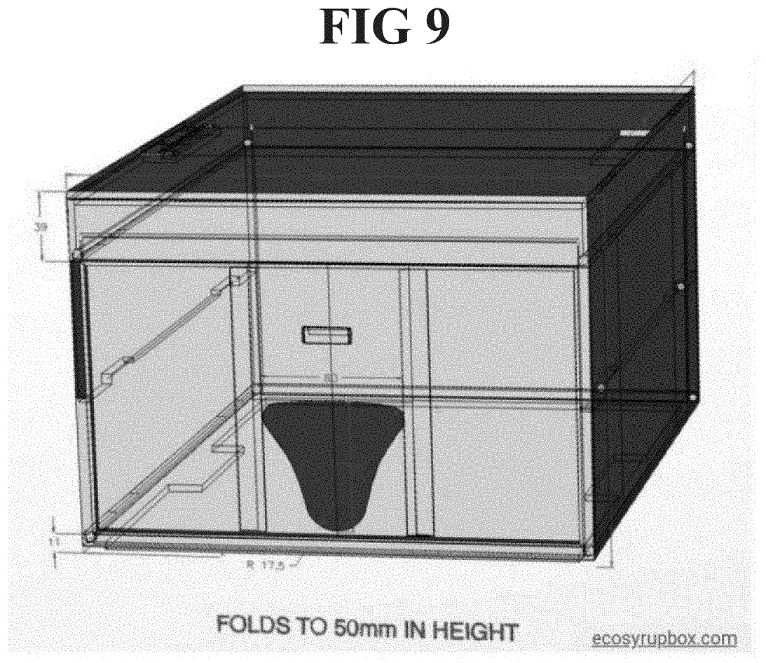

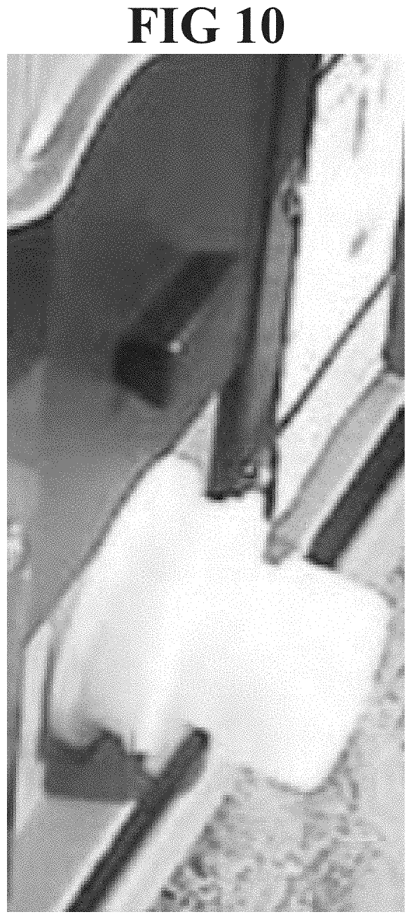

Turning now descriptively to the drawings, in which similar reference characters denote similar elements throughout the several views, FIGS. 1-10 container 100, which comprises six sides, (top 120, bottom 160, front 110, rear 130, left side 140 and right side 150). The front side 110 includes a sliding door 111 providing protected access to the internal pliable plastic pouch 200 and its fitment 210 which holds the dispensing nipple. The top side includes a large door 120 providing protected access for inserting and removing the internal pouch. The front side 110 and rear side 130 are hinged at their edges to allow them to fold inward into the cavity of the top side 120. The left side 140 and right side 150 are hinged near their horizontal centerlines to allow the container 100 to easily collapse or fold inward.

As best shown in FIGS. 1-9 of the drawings, the present invention's external frame is a rectangular box. It can be appreciated by one skilled in the art that container 100 may have various shapes such as cylinders, cubes, and other polygonal prisms. The container 100 in the example of the preferred embodiment is a right rectangular prism; however, it can be appreciated that the container 100 can have various other shapes including curved shapes. The container 100 may be solid in structure or may be comprised of a hollow structure.

It can be appreciated by one skilled in the art that the container 100 may have various cross sectional shapes such as circular, square, oval, rectangular and other well-known shapes. The container 100 is preferably straight having a single axis and a center point. However, it can be appreciated that the container 100 can have various other shapes including curved shapes.

The container 100 is preferably comprised of plastic. It can be appreciated that the container 100 may be comprised of any common material such as metal, wood, ceramic, or composite material, and incorporate woven material or pliable film.

As shown in FIGS. 1-8 of the drawings, the container 100, which includes six sides (top 120, bottom 160, front 110, rear 130, left side 140 and right side 150). The front side 110 includes a sliding door 111 providing protected access to the internal pliable plastic pouch 200 and its dispensing nipple 210. The top side 120 includes a large door providing protected access for inserting and removing the internal pouch.

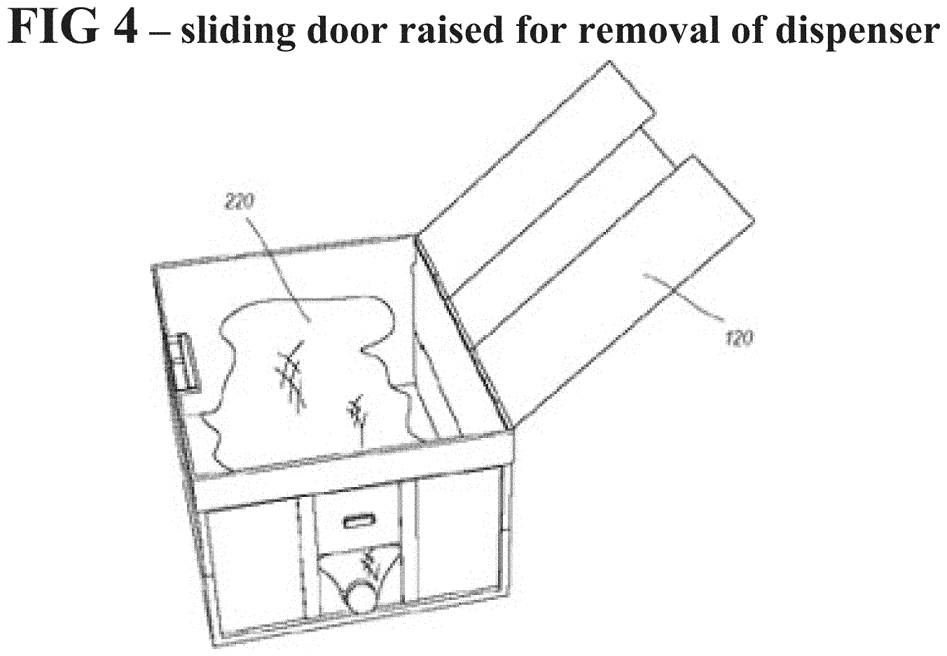

To contain a pouch filled with a fluid, the full pouch 220 is inserted via the large door in the top side 120, as depicted in FIG. 4, such that the pouch's fitment 210 which includes the dispensing nipple is positioned behind the front side 110. The fitment 210 is inserted into the nearly semi-circular cutout near the bottom center of the front side 110 such that the fitment's smallest outside diameter nests in the cutout between the flange that connects the fitment to the pouch and the fitment's next flange axially outward from the pouch, thus capturing the fitment axially and laterally. Then the sliding door 111 is lowered to capture the fitment 210 vertically

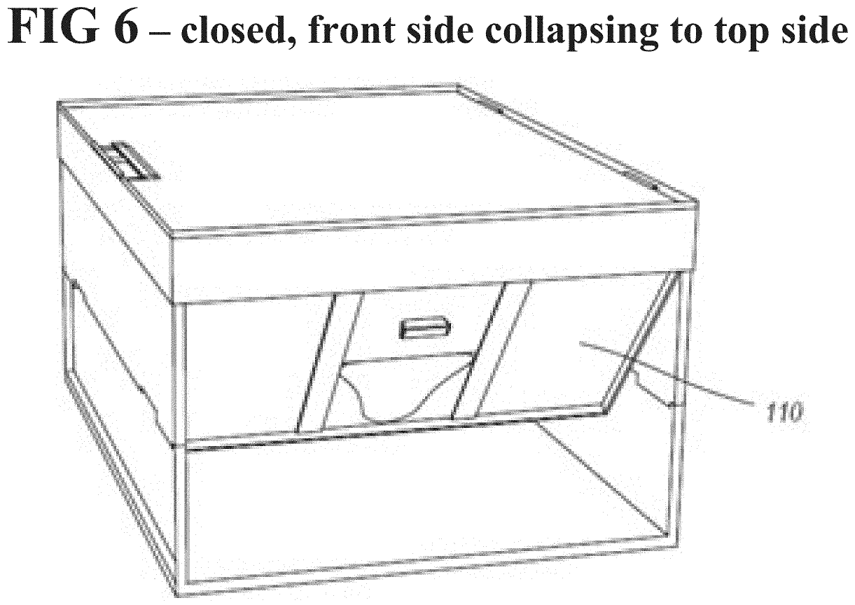

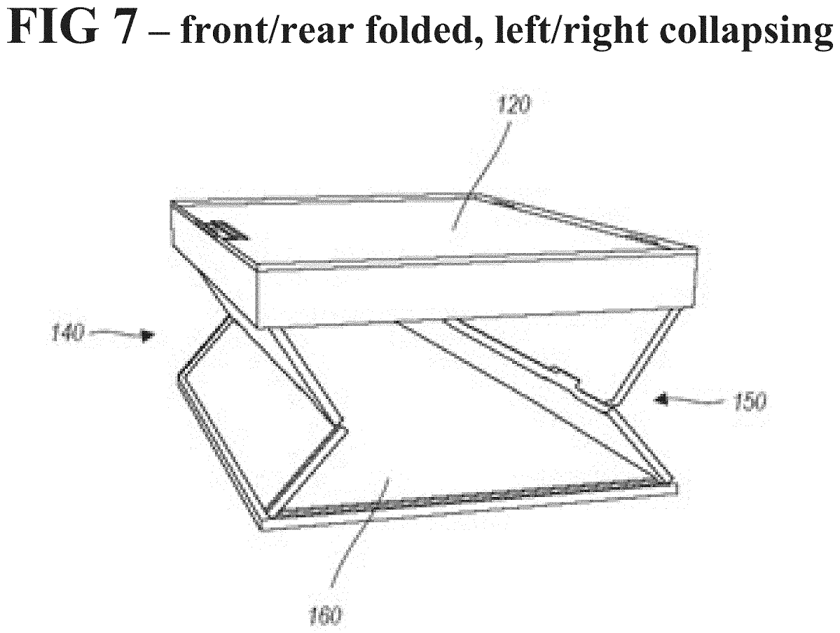

The front side 110 and rear side 130 are hinged at their edges to allow them to fold inward into the cavity of the top side 120. The left side 140 and right side 150 are hinged near their horizontal centerlines to allow the container 100 to easily collapse or fold inward. This folding is accomplished, as depicted in FIG. 6, by folding the front side 110 and rear side 130 inward and upward into the top side 120, then, as depicted in FIG. 7, folding the left side 140 and right side 150 inward at the hinges near their horizontal centerlines, causing the top side 120 top collapse downward onto the bottom side 160, achieving a much smaller profile for storage and shipment between uses.

As to a further discussion of the manner of usage and operation of the present invention, the same should be apparent from the above description.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. An apparatus for holding a material, comprising a container having six sides, said container creating a reusable frame that folds into a compact profile that can be stacked for efficient handling between uses.

2. The apparatus according to claim 1, wherein said container has external dimensions emulating those of existing single-use containers, including those designed to accommodate pliable plastic pouch liners for transport and dispensing of material.

3. The apparatus according to claim 2, wherein said container includes a front side having a 17.5 mm radius cutout to accept a 35 mm fitment of a standard pliable plastic pouch liner, and said container includes a sliding door which captures and holds the liner fast in place.

4. The apparatus according to of claim 2, wherein said container includes a top side having a hinged, latching door with one or more hinges to allow insertion and removal of a pliable plastic pouch.

5. The apparatus according to claim 4, wherein said one or more hinges are easily replaceable and of stainless-steel material.

6. The apparatus according to claim 3, wherein the front side incorporates a latching, sliding door allowing access to a dispensing nipple of a contained pliable plastic pouch when inserted into the container.

7. The apparatus according to claim 4, wherein the front side incorporates a cutout of dimension designed to accommodate a dispensing nipple of a contained pliable plastic pouch when inserted into the container.

8. The apparatus according to claim 1, wherein said container has one or more sides, said one or more sides are hinged to allow said one or more sides to fold inward to collapse said container into a compact profile for storage and transportation.

9. The apparatus according to claim 8, wherein the one or more hinges are easily replaceable and of stainless steel material.

10. The apparatus according to claim 8, wherein the container includes a folded configuration, in which configuration said container can be stacked for storage and transportation along with a plurality of other similar containers.

11. The apparatus according to claim 1, wherein the container can be used multiple times.

12. The apparatus according to claim 1, wherein the container comprises recycled plastic.

13. The apparatus according to claim 1, wherein the container comprises recyclable plastic.

14. The apparatus according to claim 1, wherein the container comprises metal.

15. The apparatus according to claim 1, wherein the container comprises wood.

16. The apparatus according to claim 1, wherein the container comprises pressed fiber.

17. The apparatus according to claim 1, wherein the container comprises ceramic material.

18. The apparatus according to claim 1, wherein the container comprises woven mesh or fabric.

19. The apparatus according to claim 1, wherein the container comprises a pliable film sheet.

20. A shipping container for transporting liquids or gases comprising:
a foldable frame having one or more hinged sides, said one or more hinged sides are hinged to allow said one or more hinged sides to fold inward to collapse said frame into a compact profile for storage and transportation;
a plastic pouch for holding a liquid or gas, which is insertable into the frame when unfolded, said pouch including a predetermined fitment and a dispensing nipple;
said foldable frame includes a front side having a predetermined radius cutout to accept the predetermined fitment of the plastic pouch; and
said front side includes a sliding door which captures and holds the pouch fast in place when in a down and locked position, and said sliding door allowing access to the dispensing nipple of the pouch when inserted into the frame.
